(19) United States
(12) Patent Application Publication
(10) Pub. No.: US 2015/0294504 A1
(43) Pub. Date: Oct. 15, 2015

(54) MARKER-BASED PIXEL REPLACEMENT

(71) Applicant: Navigate Surgical Technologies, Inc., Vancouver (CA)

(72) Inventor: Ehud (Udi) DAON, North Vancouver (CA)

(21) Appl. No.: 14/679,561

(22) Filed: Apr. 6, 2015

Related U.S. Application Data
(60) Provisional application No. 61/979,771, filed on Apr. 15, 2014.
(60) Provisional application No. 62/026,054, filed on Jul. 18, 2014.

(51) Int. Cl. G06T 19/00; G06F 3/00

(52) U.S. Cl. CPC G06T 19/006; G06F 3/005

(57) ABSTRACT

A videographic system uses a videographic camera to obtain a temporal series of digital images of a scene and substitutes the video appearance of display boards in the scene with sub-images from a database. 3D vectorized tracking markers disposed rigidly with respect to the display boards enable a controller to geometrically adapt the sub-images for changing perspectives of the videographic camera. The markers may have a rotationally asymmetric pattern of contrasting portions with perimeters that have sections that are mathematically describable curves. The markers may be monolithically integrated with the display boards. The adapted images may be supplied to an interactive display system, along with pixel coordinate information about the sub-images and resource location identifiers associated with the sub-images. This allows linking to a networked resource by selecting the sub-image with a digital pointing and selecting device. The system may be configured to replace televised advertising board information with geometrically adapted user-targeted advertisements.

### CROSS REFERENCE TO RELATED APPLICATIONS

The present application claims priority under 35 U.S.C. §119(e) of U.S. Provisional Patent Application Ser. No. 61/979,771, filed Apr. 15, 2014 and of U.S. Provisional Patent Application Ser. No. 62/026,954, filed Jul. 21, 2014, the disclosures of which are incorporated by reference herein.

### BACKGROUND OF THE INVENTION

1. Field of the Invention

The invention relates to location monitoring hardware and software systems for use in augmented reality. More specifically, the invention relates to employing tracking markers in adapting videographic images to show geometrically adapted alternative information to that which is contained in original imagery obtained by a videographic camera for use in applications including advertising.

2. Description of the Related Art

Augmented Reality (AR) is a live, direct or indirect view of a physical, real-world environment whose elements are augmented by computer-generated input such as sound, video, graphics or GPS data. The augmentation is conventionally in real-time and in semantic context with environmental elements, such as sports scores on TV during a match. With the help of advanced AR technology the information about the surrounding real world of the user becomes interactive and digitally manipulable. In other implementations, sourced information about the environment and its objects can be overlaid on the real world.

An augmented reality system generates a composite view for the user that is the combination of the real scene viewed by the user and a virtual scene generated by the computer that augments the scene with additional information. The goal of Augmented Reality is to create a system in which the user cannot tell the difference between the real world and the virtual augmentation of it. Today Augmented Reality is used in entertainment, military training, engineering design, robotics, manufacturing and other industries.

Most commonly AR systems seek to place the augmenting information in an image of the real world based on markers developed, selected, or derived within the augmenting computing system. However, there is considerable commercial and merit to systems that allow a remote viewer of a scene to overlay information on the real scene based on preselected items in the real world scene.

### SUMMARY OF THE INVENTION

In a first aspect a videographic system is provided comprising: a videographic camera configured for obtaining a temporal series of input digital images of a scene within a field of view of the videographic camera; a controller disposed and configured for receiving the temporal series of input digital images of the scene; at least one display board disposed within the field of view of the videographic camera; at least one tracking marker disposed in fixed three-dimensional spatial relationship with respect to the at least one display board; a database accessible by the controller, the database containing: at least one set of virtual sub-images associated with the at least one display board; and information about the three-dimensional spatial relationship between the at least one display board and the at least one tracking marker; a memory accessible by the controller, and software loaded into the memory, being stored in a non-volatile form, wherein the software when executed by the controller is capable of replacing in the at least one of the input digital images input pixels associated with the at least one display board with pixels from a virtual sub-image selected from among the at least one set of replacement virtual sub-images. The controller may be disposed within the videographic camera. The at least one tracking marker may be vectorized.

One area of endeavor that can benefit from AR is advertising. One example is that of sporting events and their associated advertising display boards at sports stadiums. No remote viewer wishes to experience intrusive advertising artificially floated over his or her field of view, but does accept as a current social reality any advertising that is correctly geometrically positioned on display boards. However, given that advertising display boards in a real world videographic scene are typically fixed in three dimensions, their varying position and changing perspective distortion in a videographic image of the scene severely complicate the application of Augmented Reality. A system for appropriately placing such advertising in a television video feed is therefore of considerable interest to the advertising industry.

The software when executed by the controller may further be capable of determining a three-dimensional location and orientation of the at least one tracking marker and adapting the at least one virtual sub-image to match a perspective of the videographic camera in the at least one input digital image. The database may further contain geometrical information about at least one of a three-dimensional shape of the at least one tracking marker and a rotationally asymmetric pattern on the at least tracking marker. The rotationally asymmetric pattern may comprise a plurality of contrasting portions. At least one of the plurality of contrasting portions may have a perimeter that has a mathematically describable curved section. The mathematically describable curved section may be a conic section, such as an ellipse or a circle.

The at least one display board may comprise an area on an item of clothing for a human; and the at least one tracking marker may be disposed on the item of clothing. The tracking marker may form an integrated monolithic part of the display board.

The system may further comprise a videographic recorder disposed and configured for receiving the temporal series of input digital images of the scene from the videographic camera and for supplying the temporal series of input digital images to the controller.

The software when executed by the controller may be further capable of assigning to pixels of the virtual sub-image within the at least one input digital image a resource location identifier. The system may further comprise an interactive display system disposed and configured for receiving from the controller the at least one input digital image containing pixels of the virtual sub-image, pixel coordinate information defining the virtual sub-image within the at least one input digital image, and the resource location identifier assigned to the pixels of the virtual sub-image. The display system may comprise a digital pointing and selecting device; and display system software capable when executed by the display system of directing the interactive display system to a resource location identified by the resource location identifier when the digital pointing and selecting device selects within the at least one input digital image pixels of the virtual sub-image.

In another aspect a method is presented for changing the video appearance or contents of a display board present in a temporal series of digital videographic images, the method comprising: obtaining from a videographic camera a temporal series of at least one input digital image containing the display board and at least one tracking marker rigidly disposed with respect to the display board; determining a three dimensional location and orientation of the at least one vectorized tracking marker from the at least one input digital image based on information about the at least one tracking marker in a database; first extracting from the database a fixed three-dimensional location and orientation of the display board relative to the at least one tracking marker; second extracting from the database at least one virtual sub-image associated with the display board; geometrically adapting the at least one virtual sub-image to match a perspective of the videographic camera in the at least one input digital image; and replacing within the at least one input digital image pixels corresponding to the display board with pixels corresponding to the at least one virtual sub-image.

The method may further comprise storing in the database prior to use information comprising: identifying markings on the at least one tracking marker; geometrical information about at least one of a three-dimensional shape of the at least tracking marker and a rotationally asymmetric pattern on the at least tracking marker; the fixed three-dimensional location and orientation of the display board relative to the at least one tracking marker; and the at least one virtual sub-image. The storing in the database may comprise relating the at least one virtual sub-image to the display board. The method may further comprise rigidly disposing the at least one tracking marker with respect to the display board.

In another embodiment, a plurality of vectorized tracking markers are rigidly attached directly to a given display board at known locations on display board and in known three-dimensional orientations with respect to display boar. In this embodiment, the display board may be flexible. When the videographic camera obtains a temporal series of at least one input digital image containing the display board, the display board may be flexibly deformed in three dimensions. However, the fixed spatial relationship between each tracking marker and the region of the display board to which it is rigidly attached allows the three dimensional distortion of the display board to be accurately determined from the actual three-dimensional locations and orientations of the plurality of tracking markers. The controller may therefore geometrically adapt the at least one virtual sub-image to match not only a perspective of the videographic camera in every input digital image, but may also further adapt the at least one virtual sub-image to match the three-dimensional distortion of the display board.

As regards the associated method, the obtaining the at least one input digital image may comprise in this multi-marker embodiment obtaining from the videographic camera at least one input digital image containing a plurality of tracking markers rigidly attached to the at least one display board in a fixed three-dimensional spatial relationship with respect to the at least one display board. The method may further comprise determining from the three-dimensional location and orientation of the plurality of tracking markers a distortion of the at least one display board, and further adapting the at least one virtual sub-image to match the distortion of the at least one display board in the at least one input digital image.

In another aspect, a method is provided for directing an interactive display system to an information source, the method comprising: associating with a set of virtual sub-images in a database a set of corresponding resource location identifiers; replacing at least one portion of at least one input digital image in a temporal series of input digital images from a videographic camera with one of the virtual sub-images while changing the at least one portion based on a changing perspective of the camera; transferring to the interactive display system the changed temporal series of digital images, associated sub-image pixel coordinate information, and the corresponding resource location identifiers; displaying on the interactive display system the changed temporal series of digital images; assigning the corresponding resource location identifiers to the changed portions; and directing the interactive display system to one of the resource locations when a corresponding associated changed portion is selected on the interactive display system.

The replacing the at least one portion may comprise: obtaining from the videographic camera the temporal series of input digital images containing a display board and at least one vectorized tracking marker rigidly disposed with respect to the display board; determining a three dimensional location and orientation of the at least one tracking marker from the at least one input digital image based on information about the at least one tracking marker in the database; first extracting from the database a fixed three-dimensional location and orientation of the display board relative to the at least one tracking marker; second extracting from the database at least one virtual sub-image associated with the display board; geometrically adapting the at least one virtual sub-image to match a perspective of the videographic camera in the at least one input digital image; and replacing within the at least one input digital image pixels corresponding to the display board with pixels corresponding to the at least one virtual sub-image.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized as controller and display in conjunction with embodiments of the present invention.

FIG. 3 is a partially schematic diagram of a videographic system for the receiver-specific replacement of image segments of videographic images based on three-dimensional vectorized tracking markers within the videographic images.

FIG. 4 is a drawing of a flow chart describing a method for producing a temporal series of audience-customized output digital images from a series of input digital images based on three-dimensional vectorized tracking markers within videographic images.

FIG. 5 is a partially schematic diagram of a videographic system for receiver-specific replacement of image segments of videographic images based on three-dimensional vectorized tracking markers within recorded videographic images.

FIGS. 6A, 6B, and 6C show three embodiments of an interactive video system directable to an information source by means of receiver-specific replacement of segments of videographic images based on three-dimensional vectorized tracking markers within recorded videographic images.

FIG. 7 is a drawing of a flow chart describing a method for directing an interactive video system to an information source by means of receiver-specific replacement of segments of videographic images based on three-dimensional vectorized tracking markers within recorded videographic images.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiments disclosed below are not intended to be exhaustive or limit the invention to the precise form disclosed in the following detailed description. Rather, the embodiments are chosen and described so that others skilled in the art may utilize their teachings.

The detailed descriptions that follow are presented in part in terms of algorithms and symbolic representations of operations on data bits within a computer memory representing alphanumeric characters or other information. A computer generally includes a processor for executing instructions and memory for storing instructions and data. When a general-purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements that impart or manifest a physical organization on the information stored in memory. More than mere abstraction, the data structures are specific electrical or magnetic structural elements in memory that simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein that form part of embodiments of the present invention; the operations are machine operations. Useful machines for performing the operations of embodiments of the present invention include general-purpose digital computers or other similar devices. In all cases the distinction between the method operations in operating a computer and the method of computation itself should be recognized. The various embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

Some embodiments of the present invention also relate to an apparatus for performing these operations. This apparatus may be specifically constructed for the required purposes or it may comprise a general-purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols that may or may not require specific hardware or programming to interact. In particular, various general-purpose machines may be used with programs written in accordance with the teachings herein, or it may prove more convenient to construct more specialized apparatus to perform the required method steps. The required structure for a variety of these machines will appear from the description below.

In the following description, several terms that are used frequently have specialized meanings in the present context. The terms “network”, “local area network”, “LAN”, “wide area network”, or “WAN” mean two or more computers that are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “writing” or “storing” or “replicating” or the like, refer to the action and processes of a computer system, or similar electronic computing device that manipulates and transforms data represented as physical (electronic) quantities within the computer system's registers and memories and other computer readable media into other data similarly represented as physical quantities within the computer system memories or registers or other such information storage, transmission or display devices. “Databases” comprise the actual storage on a physical storage device (e.g., a disk drive), which works in combination with corresponding software. In exemplary scenarios, a database comprises tables and records that are laid out in an ordered sequence of bytes. A software application that accesses the physical data on the storage device has a template of the layout, and may retrieve information from certain portions or fields in the data. “Relational” database systems store data in relational structures, such as tables and indexes. However, the actual format in which the data is stored, retrieved, and manipulated, often bears little relationship to the logical structure of a table. Various database languages have been developed to easily access data that is managed by relational database systems. One common database language is SQL. Such languages allow users to form queries that reference the data as if the data were actually stored in relational structures. However, the actual structures in which the relational data is stored and accessed is often significantly more complicated than simple two-dimensional tables. A database server stores data in one or more data containers. Each container contains records. The data within each record is organized into one or more fields. In a database system that stores data in a relational database, the data containers are referred to as tables, the records are referred to as rows, and the attributes are referred to as columns. In object-oriented databases, the data containers are referred to as object classes, the records are referred to as objects, and the attributes are referred to as object attributes. Other database architectures may use other terminology.

“PACS” refers to Picture Archiving and Communication System (PACS) involving medical imaging technology for storage of, and convenient access to, images from multiple source machine types. Electronic images and reports are transmitted digitally via PACS; this eliminates the need to manually file, retrieve, or transport film jackets. The universal format for PACS image storage and transfer is DICOM (Digital Imaging and Communications in Medicine). Non-image data, such as scanned documents, may be incorporated using consumer industry standard formats like PDF (Portable Document Format), once encapsulated in DICOM. A PACS typically consists of four major components: imaging modalities such as X-ray computed tomography (CT) and magnetic resonance imaging (MRI) (although other modalities such as ultrasound (US), positron emission tomography (PET), endoscopy (ES), mammograms (MG), Digital radiography (DR), computed radiography (CR), etc. may be included), a secured network for the transmission of patient information, workstations and mobile devices for interpreting and reviewing images, and archives for the storage and retrieval of images and reports. When used in a more generic sense, PACS may refer to any image storage and retrieval system.

In addition to single images, multiple images are often combined into a video stream. Various methods and systems have been developed for encoding and decoding a video stream. Each picture in a video stream may be divided into slices, each of which contains a contiguous row of macroblocks; each macroblock may contain multiple blocks corresponding of all video components to the same spatial location. In such embodiments, the blocks within each slice may be used as the basis for encoding the picture. By encoding multiple blocks in a single process using certain scan patterns, the video stream may efficiently be converted for displays of varying sizes. In some embodiments, the encoded bitstream may include a slice table to allow direct access to each slice without reading the entire bitstream. Each slice may also be processed independently, allowing for parallelized encoding and/or decoding. Various methods and systems have been developed for encoding and decoding a video stream. Each picture in a video stream may be divided into slices, each of which may contain a contiguous row of macroblocks; each macroblock may contain multiple blocks corresponding of all video components to the same spatial location. The blocks within each slice may be used as the basis for encoding the picture. By encoding multiple blocks in a single process using certain scan patterns, the video stream may efficiently be converted for displays of varying sizes. In some embodiments, the encoded bitstream may include a slice table to allow direct access to each slice without reading the entire bitstream. Each slice may also be processed independently, allowing for parallelized encoding and/or decoding.

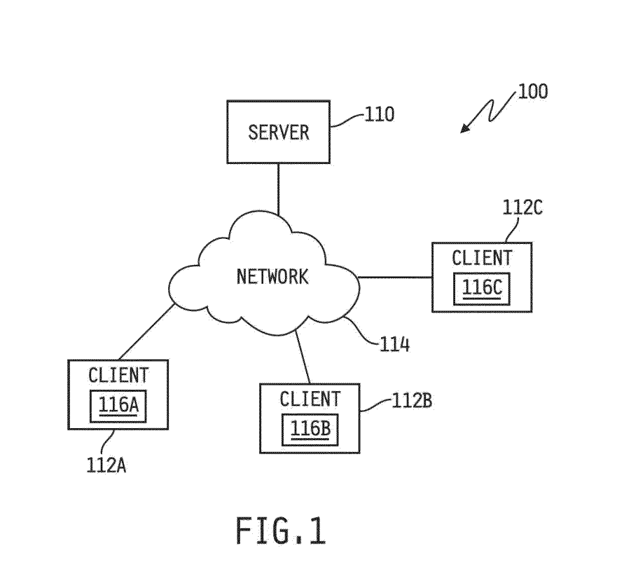

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

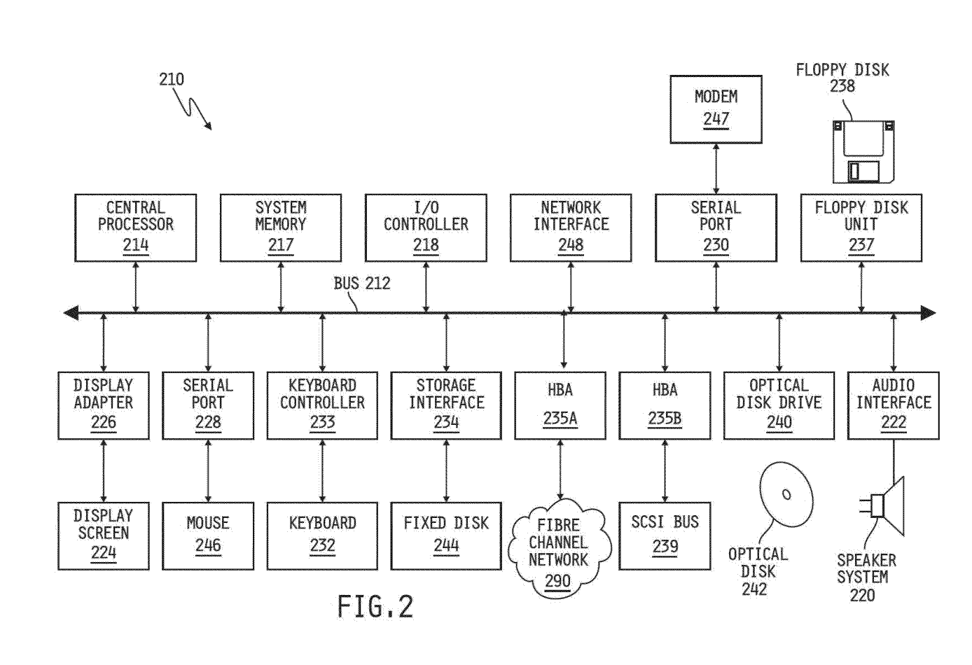

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) that controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above-described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

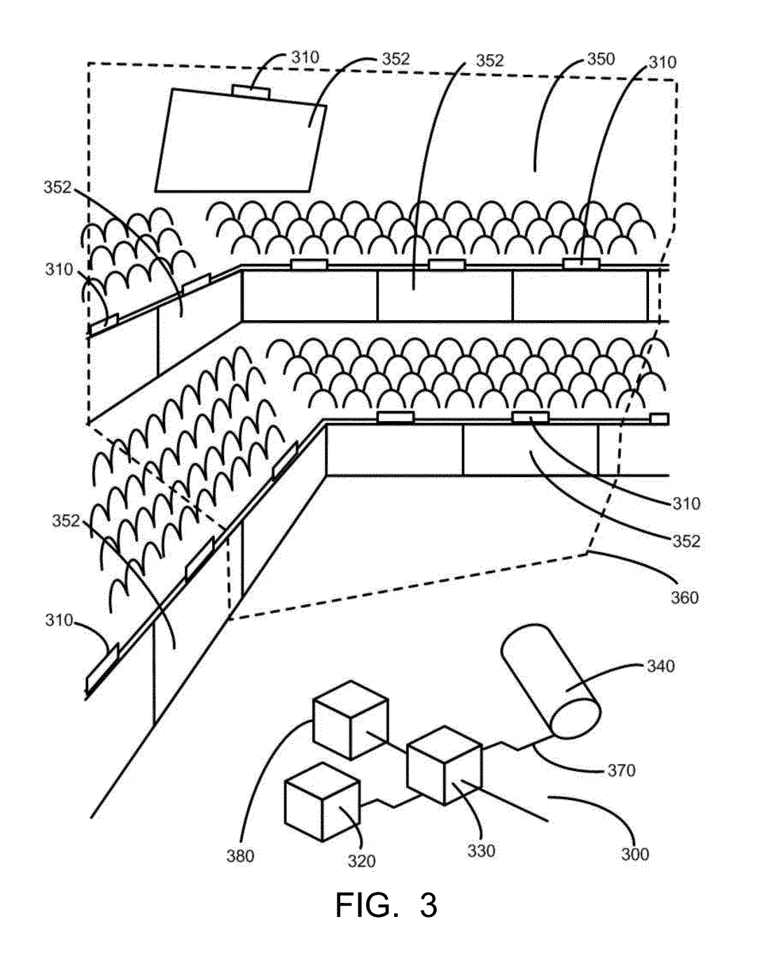

The present invention relates to embodiments of a videographic system and method that allows for the processing of videographic images for receiver-specific replacement of image segments based on three-dimensional vectorized tracking markers identified within the videographic images. In the schematic videographic system 300 of FIG. 3, tracking marker 310 is at least one of shaped and marked to allow its location and orientation to be determined in three dimensions. The term “vectorized” is used in this specification to describe tracking markers that are at least one of shaped and marked so as to make their orientation in three dimensions uniquely determinable from their appearance in an image produced by a videographic camera. If their three-dimensional orientation is determinable, then their three-dimensional location is also known. For the purposes of the present specification we shall proceed to describe videographic system 300 at the hand of specific vectorized tracking marker 310 described in co-pending U.S. patent application Ser. No. 13/713,165 titled “System and method for determining the three-dimensional location and orientation of identification markers”, which is hereby incorporated by reference in full.

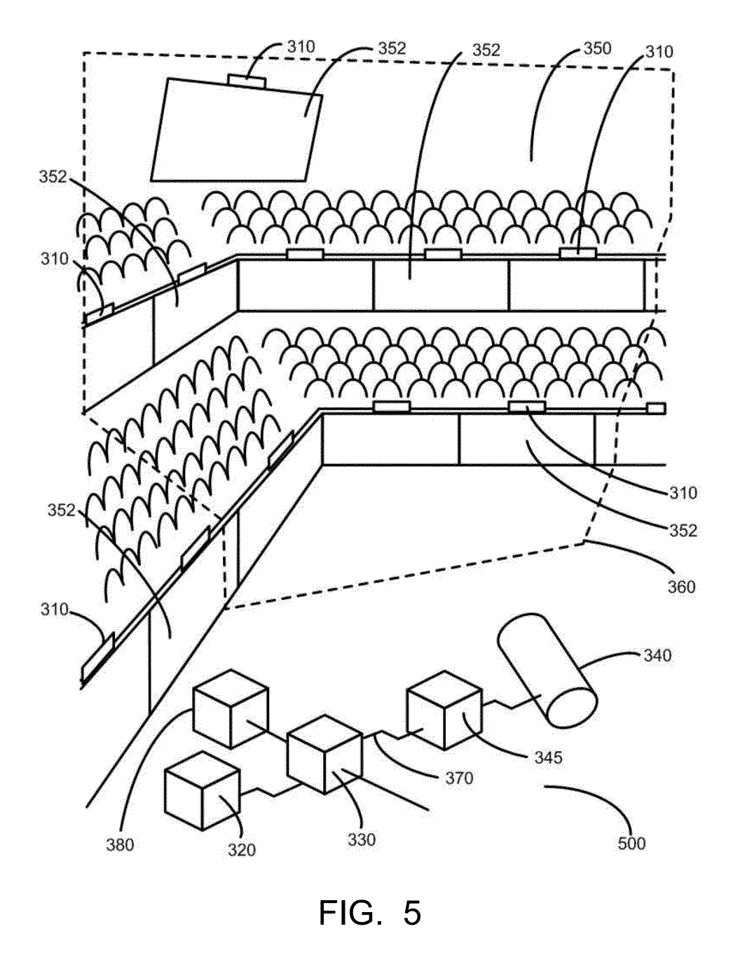

The markings on vectorized tracking marker 310, as described in U.S. patent application Ser. No. 13/713,165, comprise a plurality of contrasting portions arranged in a rotationally asymmetric pattern and at least one of the contrasting portions has a perimeter that has a mathematically describable curved section. The perimeter of the contrasting portion may comprise a conic section, including for example an ellipse or a circle. The markings may be monolithically integrated with tracking marker 310. In other embodiments the markings may be scribed, engraved, stamped, embossed or otherwise formed on tracking marker 310. Geometric information about the asymmetric pattern may be stored in database 320 prior to use of system 300. Controller 330, for example central processor 214 of FIG. 2, may be used to access the geometric information in database 320. Controller 330 may be a computer or a dedicated microprocessing system or any other suitable computing device capable of videographic editing at individual pixel level and capable of geometrical computation. Controller 330 is disposed and configured to receive videographic image information of scene 350 as obtained by videographic camera 340. In some embodiments, controller 330 may be incorporated within videographic camera 340. In other embodiments, controller 330 may be located remotely from videographic camera 340. For the sake of clarity in FIG. 3, controller 330 and its associated database 320 are shown distinct from videographic camera 340. In other embodiments, as described later below at the hand of FIG. 5, videographic image information of scene 350 as obtained by videographic camera 340 may be recorded by a suitable videographic recorder and subsequently supplied to controller 330.

By way of example, scene 350 may be a scene of a sporting match in a sport stadium. The scene may contain display board 352 bearing real display board image information. The real display board image information is most typically of an advertising nature, but may more generally comprise any displayable information. Most typically, the arrangement of display boards at a sport stadium comprises a plurality of display boards 352 around the perimeter of the field in front of the spectators, further display boards 352 above or behind the spectators, the spectators being located in stands 356. Typically one or more large display boards 352 are located high above the spectators, usually displaying the score of the sporting match, but sometimes dedicated to advertising or some current issue of interest. All of the above, along with one or more player 356 may be located in the camera field of view 360 of videographic camera 340. Player 356 may be wearing further tracking marker 310 and have an area on his or her clothing that is dedicated to sponsorship or advertising. This area of clothing serves the same function as display boards 352. The term “display board” is therefore taken in the present specification to also include an area on a player's clothing dedicated to advertising or sponsorship.

In database 320 each vectorized marker 310 is associated with one or more display boards 352 and database 320 is provided with information describing the exact three-dimensional spatial location and orientation of tracking marker 310 relative to each display board 352 associated with tracking marker 310. This data may be added to the database when markers 310 are initially rigidly disposed, for example at the stadium, with respect to the display boards 352 with which vectorized markers 310 are associated. The same relationship holds true between tracking marker 310 worn by player 356 and the area on his or her clothing that is dedicated to sponsorship or advertising.

Within database 320, each display board 352 is furthermore associated with a set of blocks of image information to be virtually displayed on display board 352. The term “virtual sub-image” is used in this specification to describe a block of image information to be virtually displayed on display board 352 within the transmitted data stream from system 300 instead of the real information on that particular display board 352. The virtual sub-images may be advertisements or other announcements provided by interested parties. The virtual sub-images may be, for example without limitation, the subject of a business arrangement with a sponsor or advertising party. The virtual sub-images in a set may by sequenced in time on some agreed basis or may be selected at random within a set.

Videographic camera 340 produces a temporal series of input digital images of the portion of scene 350 located within field of view 360. The temporal series of input digital images is passed to controller 330 on input line 370. Input line 370 may be wired or may be any other form of transmission medium suitable for transmitting videographic image information. In some embodiments, controller 330 may therefore be remote from controller 330.

When controller 330 receives a digital image in the temporal series, it analyzes the digital image to search for vectorized tracking marker 310. Upon identifying for example tracking marker 310 in the digital image, controller 330 searches database 320 for the information associated with marker 310. Controller 330 finds in database 320 the relative orientation and location information for each display board 352 with respect to marker 310 with which it is associated. Controller 330 also finds the set of stored display board virtual sub-images in database 320 that is associated with each display board 352.

Based on any sequencing information retrieved from database 320, controller 330 performs pixel replacement on the current digital image in the temporal series, replacing the pixels corresponding to each display board 352 with corresponding pixels from the stored and sequenced display board virtual sub-images. Since the exact orientation and location of each display board 352 relative to marker 310 is known, and the orientation and location of marker 310 relative to videographic camera 340 is known, controller 330 applies to the stored virtual sub-images the required distortion to match the perspective videographic camera 340 has of the individual associated display boards 352. Controller 330 may execute the above steps based on software loaded into memory 380, for example system memory 217 of FIG. 2.

Having by the above method replaced the real display board image information on display boards 352 with the stored and sequenced display board virtual sub-images, controller 330 transmits the adapted digital image along the transmission path to users. The users may be at a remote location and the stored display board virtual sub-images may be chosen to suit or address these specific users, whereas the real display board information may suit and be addressed to local spectators at the stadium. Videographic system 300 therefore provides a method for producing a temporal series of audience-customized output digital images from a series of input digital images.

A plurality of vectorized tracking markers 310 may be associated with a particular display board 352 and a plurality of display boards may be associated with a given tracking marker 310. The multiple tag-to-display board configuration of system 300 allows different videographic cameras 340 to view the same scene 350 from different angles and locations with different fields of view 360 and improves the likelihood that a given videographic camera 340 will have a good view of tracking markers 310 associated with display boards 352 in the field of view 360 of the particular videographic camera 340.

In some embodiments, vectorized tracking markers 310 may be supplied integral with display boards 352. In yet further embodiments, tracking markers 310 may be monolithically integrated with rigid structural components of display boards 352, tracking markers 310 being manufactured along with rigid structural components of display boards 352 in the same processing step, such as, for example without limitation, injection molding or casting.

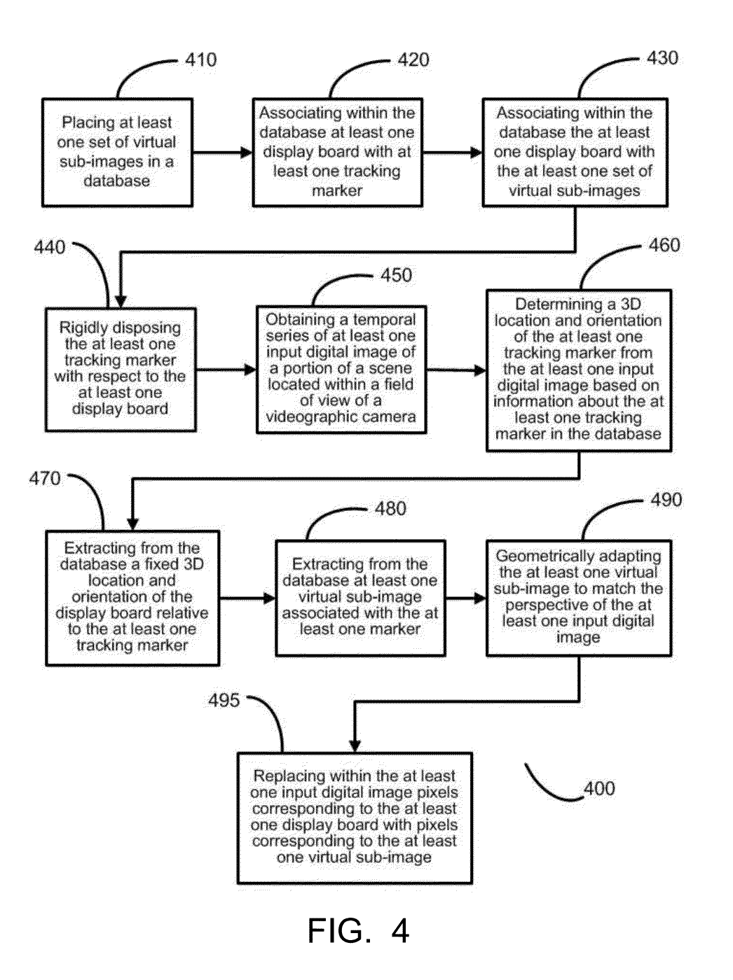

A method [400] of using videographic system 300 to produce a temporal series of audience-customized output digital images from a series of input digital images may be described as follows at the hand of the flow chart of FIG. 4. The method [400] comprises: placing [410] in database 320 at least one set of virtual sub-images comprising at least one virtual sub-image; first associating [420] within database 320 at least one display board 352 with at least one vectorized tracking marker 310; second associating [430] within database 320 the at least one display board 352 with the at least one set of virtual sub-images; rigidly [440] disposing the at least one tracking marker 310 with respect to the at least one display board 352; obtaining [450] a temporal series of at least one input digital image of a portion of scene 350 containing the at least one display board 352 and the at least one tracking marker 310 located within a field of view 360 of a videographic camera 340; determining [460] a three dimensional location and orientation of the at least one tracking marker 310 from the at least one input digital image based on information about the at least one tracking marker 310 in a database 320; first extracting [470] from database 320 a fixed three-dimensional location and orientation of the display board relative to the at least one tracking marker 310; second extracting [480] from database 320 the at least one virtual sub-image associated with the at least one display board 352; geometrically adapting [490] the at least one virtual sub-image to match a perspective of the at least one input digital image; and replacing [495] within the at least one input digital image pixels corresponding to the at least one display board 352 with pixels corresponding to the at least one virtual sub-image. The second associating [430] comprises storing in database 320 the relative 3D location and orientation of the at least one display board 352 relative to the at least one tracking marker 310. The first extracting [470] comprises extracting from database 320 the relative 3D location and orientation of the at least one display board 352 relative to the at least one tracking marker 310. Detailed methods for determining orientations and locations of tracking markers from input digital images are known to practitioners of the art and will not be dwelt upon here. For purposes of later reference in this specification, method 400 may also be summarized as replacing portions of digital images in a temporal series of input digital images from a videographic camera with virtual sub-images while changing the portions based on a changing perspective of the videographic camera, thus changing the video appearance of the display board.

The software when executed by controller 330 is further capable of determining a three-dimensional location and orientation of the at least one vectorized tracking marker 310 and adapting the at least one virtual sub-image to match a perspective of videographic camera 340 in the at least one input digital image.

In the present specification the phrase “monolithically integrated” is used to describe items that are fashioned together from one piece of material. This to be contrasted with a situation where the items are joined together after manufacture, either detachably or through a non-integral coupling. In this particular example a suitable rigid positioning and orienting portion of display board 352 is its frame. The frame may, for example be molded, cast, machined or otherwise fashioned from one monolithic piece of material and vectorized tracking marker 310 is fashioned, formed or made from the same monolithic piece of material. Tracking marker 310 may be formed during the same process as that within which the frame of display board 352 is made.

To the extent that vectorized tracking marker 310 is monolithically integrated with the frame of display board 352, and the position and orientation of monolithically integrated tracking marker 310 relative to the information-bearing part of display board 352 is fixed and known, knowledge of the three-dimensional position and orientation of vectorized tracking marker 310 within the field of view of videographic camera 340 provides the user with the location and orientation of the information bearing portion of display board 352.

The monolithic integration of three-dimensional tracking markers with a rigid positioning and orienting portion of a display board is not limited to sporting display boards. It may be applied to any information-bearing item having a suitable rigid positioning and orienting portion and, indeed, to any apparatus having a suitable rigid positioning and orienting portion.

Vectorized tracking marker 310 may be shaped in three dimensions so as to allow its orientation to be determined from a two-dimensional input digital image of display board 352 within the field of view of videographic camera 340. In further embodiments, monolithically integrated tracking marker 310 may have a monolithically integrated marking so as to allow its orientation to be determined from a two-dimensional image of display board 352 within the field of view of videographic camera 340. In further embodiments tracking marker 310 may be both shaped and marked to allow its orientation, its location, or both to be determined.

In yet further embodiments, positioning and orienting markings may be scribed, engraved, stamped, embossed or otherwise formed on tracking marker 310. Useful markings for determining the location and orientation of tracking marker 310 are described in co-pending U.S. patent application Ser. No. 13/713,165, U.S. Patent Publication No. US 2014-0126767 A1, titled “System and method for determining the three-dimensional location and orientation of identification markers”, which is hereby incorporated in full by reference.

The markings on tracking marker 310 as described in patent application Ser. No. 13/713,165 comprise a plurality of contrasting portions arranged in a rotationally asymmetric pattern. At least one of the contrasting portions may have a perimeter that has a mathematically describable curved section. The perimeter of the contrasting portion may comprise a conic section, including for example an ellipse or a circle. The markings may be monolithically integrated with the tracking marker. In other embodiments the markings may be scribed, engraved, stamped, embossed or otherwise formed on tracking marker 310. The geometric information stored in database 320 may comprise information about the asymmetric pattern. A suitable controller, for example processor 214 and memory 217 of computer 210 of FIG. 2, may be used to compare the input digital image obtained from videographic camera 340 with the geometric information about tracking marker 310 in order to determine the three dimensional location and orientation of tracking marker 310 and its display boards 352.

In other embodiments, a plurality of vectorized tracking markers 310 are rigidly attached directly to a given display board 352 at known locations on display board 352 and in known three-dimensional orientations with respect to display board 352. In this embodiment, display board 352 may be flexible. When videographic camera 340 obtains a temporal series of at least one input digital image containing display board 352, display board 352 may be flexibly deformed in three dimensions. However, the fixed spatial relationship between each tracking marker and the region of display board 352 to which it is rigidly attached allows the three dimensional distortion of display board 352 to be accurately determined from the actual three-dimensional locations and orientations of the plurality of tracking markers 310. Controller 330 may therefore geometrically adapt the at least one virtual sub-image to match not only a perspective of the videographic camera in every input digital image, but may also further adapt the at least one virtual sub-image to match the three-dimensional distortion of display board 352.

As regards the associated method, obtaining [450] the at least one input digital image as described at the hand of FIG. 4 may comprise in this multi-marker embodiment obtaining from the videographic camera 340 at least one input digital image containing a plurality of vectorized tracking markers 310 rigidly attached to the at least one display board 352 in a fixed three-dimensional spatial relationship with respect to the at least one display board 352. The method may further comprise determining from the three-dimensional location and orientation of the plurality of vectorized tracking markers 310 a distortion of the at least one display board 352, and further adapting the at least one virtual sub-image to match the distortion of the at least one display board 352 in the at least one input digital image.

FIG. 5 shows a videographic system 500, wherein the same numbers indicate the same elements as in embodiments described with reference to videographic system 300 of FIG. 3. In FIG. 5, videographic camera 340 provides live videographic image information of scene 350 to videographic recorder 345 and videographic recorder 345 records the live videographic image information of scene 350. In FIG. 5B, controller 330 is disposed and configured for receiving the recorded videographic image information of scene 350 from videographic recorder 345. To the extent that controller 330 in this embodiment, as in embodiments described above, bases any pixel replacement actions wholly on the content of the videographic image information, the embodiment shown in FIG. 5 functions exactly as the embodiments described above. In this respect, controller 330 does not differentiate between recorded and live videographic information. The matter of whether videographic information processed by controller 330 is live or recorded may be clarified to viewers by another means apart from any shown in the present embodiments.

A method associated with this embodiment may also be described by the steps in the flow chart of FIG. 4. Step [450] of method [400] in that flow chart does not specify the source of the at least one input digital image. Input digital image, in the case of live videography, is sourced directly from the videographic camera 340 via input line 370 as per FIG. 3, while, in the case of recorded videographic image information as per FIG. 5, the input digital image is sourced from videographic recorder 345 via input line 370. Input line 370 may be wired or may be any other form of transmission medium suitable for transmitting videographic image information. Similarly, the link between videographic camera 340 and videographic recorder 345 may be wired or may be any other form of transmission medium suitable for transmitting videographic image information. In some embodiments, videographic recorder 345 may be disposed remotely from videographic camera 340. In some embodiments, videographic recorder 345 may be disposed remotely from controller 330.

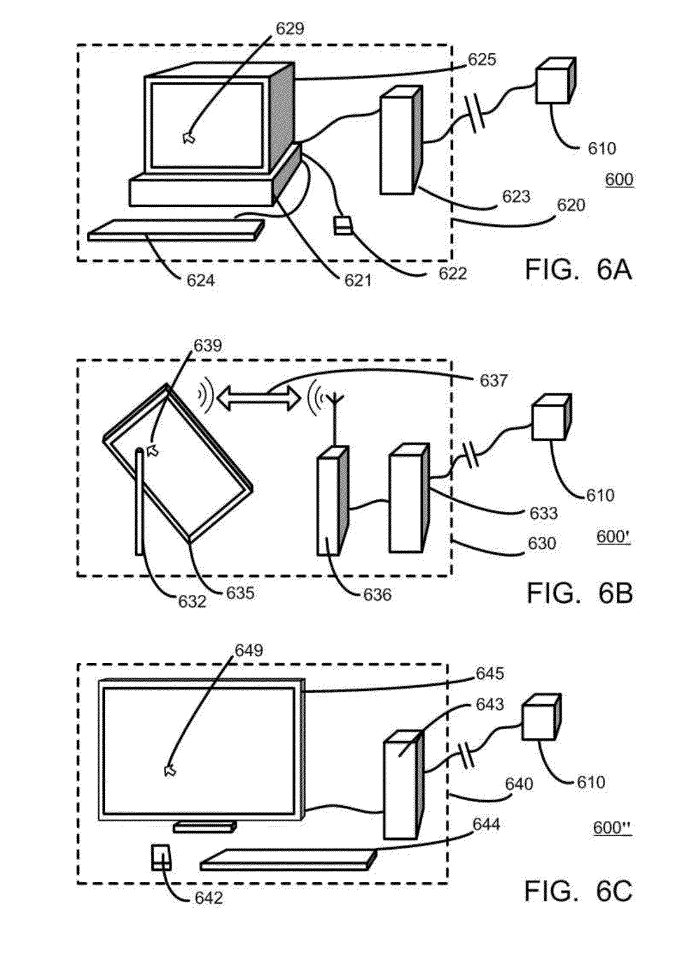

In a further aspect, FIGS. 6A, 6B, and 6C respectively show an interactive video system 600, 600′, 600″ comprising videographic system 610, being one of system 300 of FIG. 3 and system 500 of FIG. 5, providing to interactive display system 620, 630, 640 respectively a temporal series of audience-customized digital images derived from a series of input digital images as described above. Interactive video system 600, 600′, 600″ may be configured, for example in software or in firmware, to render user-selectable to the user of display system 620, 630, 640 any pixels replaced with a displayed virtual sub-image. Since the videographic camera 340 used to obtain the input digital image varies its perspective, viewing direction, “zoom” factor, and its field of view, the clickable region of the input digital image varies dynamically and is updated “in real time” or “on the fly”.

In FIG. 6A interactive display system 620 may comprise, for example without limitation, a personal computer monitor 629 driven by a computer 621 served by a keyboard 624 and a digital pointing and selecting device 622, such as a digital mouse, track-ball, or the like. The digital pointing and selecting device 622 is used to position a pointer 629 on monitor 629 and may be employed to select a clickable hyperlink or area on monitor 629. Computer 621 obtains the temporal series of audience-customized digital images from videographic system 610 via digital modem 623 on a suitable wired or wireless line.

In FIG. 6B interactive display system 630 may comprise a touch-screen device 635, for example without limitation a digital tablet, smartphone, notebook or the like, that allows control of pointer 639 and selecting of a clickable hyperlink or area on touch-screen device 635 by means of human touch or touch by a suitable stylus 632. Touch-screen device 635 obtains the temporal series of audience-customized digital images from videographic system 610 via digital modem 633 on a suitable wired or wireless line and thence via wireless access point 636 and wireless link 637.

In FIG. 6C interactive display system 640 may comprise, for example without limitation, a “Smart television” 645 equipped with a suitable keyboard 644, wired or wireless, remote control, or other television control device 642 that allows the user to move pointer 649 on the display of “Smart television” 645 and to select a hyperlink or pixel-region on the television display. A variety of such control devices, ranging from an inertial digital mouse, through digital camera-based human gesture input devices, to handheld touchpad devices are known in the art and will not be discussed in more detail here. Smart television 645 obtains the temporal series of audience-customized digital images from videographic system 610 via digital modem 643 on a suitable wired or wireless line.

From the perspective of the user, the user is pointing at and selecting whatever imagery is being displayed in the virtual sub-image substituted for the display board 352. Upon selecting the imagery, display system 620, 630, 640 may be directed to an alternative information source. The alternative information source may be a website, an alternative video feed, or any other information source to which the user may be usefully directed. To this end, interactive display system 620, 630, 640 may comprise software capable of directing interactive display system 620, 630, 640 to a resource location identified by the resource location identifier when digital pointing and selecting device 622, 632, 642 selects within the input digital image pixels of the virtual sub-image. In other embodiments, upon selecting the imagery, the display device may undertake an action, such as, for example, phoning a telephone number or generating e-mail to a predetermined address. In yet further embodiments, upon selecting the imagery, display system 620, 630, 640 may present in the place of the virtual sub-image, and therefore in the place of display boards 352, other useful information such as, for example, historic scores in sports matches or other relevant information. By these various mechanisms the virtual sub-image area is presented to the user as a “clickable image” or “clickable link” directing the user to other information sources or guide the user to actions.

As per the pixel-replacement method described above, the controller 330 is already in possession of the geometric data describing exactly which pixels are being replaced with virtual sub-images from database 320. Controller 330 may therefore define in terms of pixels the area in a given input digital image of a portion of scene 350 that represent the at least one display board 352. Controller 330 may be configured, for example in firmware or software, to transmit to interactive display system 620, 630, 640 the pixel coordinates defining the clickable region of the input digital image being displayed on interactive display system 620, 630, 640. In other embodiments, controller 330 may be configured to transmit to interactive display system 620, 630, 640 the coordinates of corners defining a clickable area of the input digital image being displayed on interactive display system 620, 630, 640. In the present specification the phrase “pixel coordinate information” is used to describe any such information that may be employed to fully define the location, shape, and extent of a sub-image area or clickable area of the input digital image being displayed on interactive display system 620, 630, 640. Controller 330 may also transmit to interactive display system 620, 630, 640 a uniform resource locator (URL), or other resource location identifier, to be assigned to the clickable area. In the present specification, the phrase “resource location identifier” is used as a general phrase to describe a network location that is accessible, at least at some point in time, to the interactive display system 620, 630, 640.

From a user perspective, the resulting video imagery presents itself as a video feed on the user's interactive display system 620, 630, 640, with the “clickable image” areas within the image varying dynamically in time with the overall image content, the latter being determined by the perspective, “zoom” factor, field of view, and view direction of videographic camera 340, which is serving as the original source of the videographic information, whether live or from a recording.

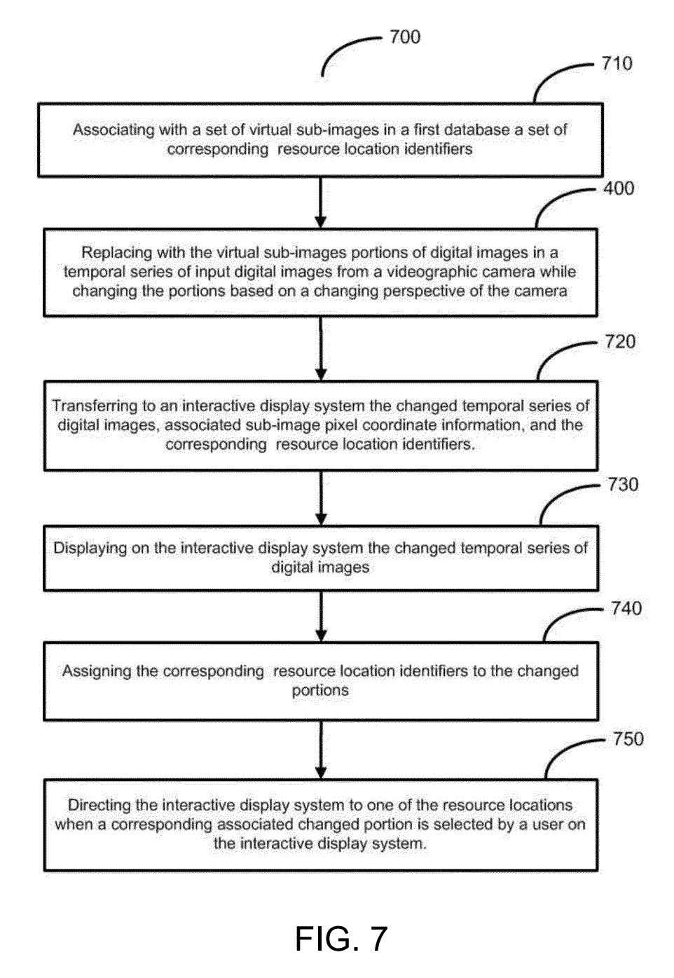

FIG. 7 is a flow chart of a method for directing [700] an interactive display system 620, 630, 640 to an information source, the method comprising: associating [710] with a set of virtual sub-images in a first database a set of corresponding resource location identifiers; replacing [400] (See above along with FIG. 4) replacing at least one portion of at least one input digital image in a temporal series of input digital images from a videographic camera with one of the virtual sub-images while changing the at least one portion based on a changing perspective of the camera; transferring [720] to the interactive display system 620, 630, 640 the changed temporal series of digital images, associated sub-image pixel coordinate information, and the corresponding resource location identifiers; displaying [730] on the interactive display system 620, 630, 640 the changed temporal series of digital images; assigning [740] the corresponding resource location identifiers to the changed portions; and directing [750] the interactive display system 620, 630, 640 to one of the resource locations when a corresponding associated changed portion is selected on the interactive display system 620, 630, 640.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A videographic system comprising:
a. a videographic camera configured for obtaining a temporal series of input digital images of a scene within a field of view of the videographic camera;
b. a controller disposed and configured for receiving the temporal series of input digital images of the scene from the videographic camera;
c. at least one display board disposed within the field of view of the videographic camera;
d. at least one vectorized tracking marker disposed in fixed three-dimensional spatial relationship with respect to the at least one display board;
e. a database accessible by the controller, the database containing:
i. at least one set of virtual sub-images associated with the at least one display board; and
ii. information about the three-dimensional spatial relationship between the at least one display board and the at least one tracking marker;
f. a memory accessible by the controller, and
g. software stored in a non-volatile form in the memory,
wherein the software when executed by the controller is capable of replacing in at least one of the input digital images input pixels associated with the at least one display board with pixels from a virtual sub-image selected from among the at least one set of virtual sub-images.

2. The system of claim 1, wherein the software when executed by the controller is further capable of determining a three-dimensional location and orientation of the at least one tracking marker and adapting the at least one virtual sub-image to match a perspective of the videographic camera in the at least one input digital image.

3. The system of claim 1, wherein the database further contains geometrical information about at least one of a three-dimensional shape of the at least one tracking marker and a rotationally asymmetric pattern on the at least tracking marker.

4. The system of claim 3, wherein the rotationally asymmetric pattern comprises a plurality of contrasting portions.

5. The system of claim 4, wherein at least one of the plurality of contrasting portions has a perimeter that has a mathematically describable curved section.

6. The system of claim 5, wherein the mathematically describable curved section is a conic section.

7. The system of claim 6, wherein the conic section is one of an ellipse and a circle.

8. The system of claim 1, wherein the fixed three-dimensional spatial relationship is a monolithic integrated relationship.

9. The system of claim 1, wherein
a. the at least one display board is a flexible display board;
b. the at least one tracking marker is a plurality of vectorized tracking markers;
c. each of the plurality of tracking markers is rigidly attached to the at least one display board in a fixed three-dimensional spatial relationship with respect to the at least one display board.

10. The system of claim 9, wherein the software when executed by the controller is further capable of determining from the three-dimensional location and orientation of the at least one tracking marker a flexible distortion of the at least one display board and further adapting the at least one virtual sub-image to match the distortion of the at least one display board in the at least one input digital image.

11. The system of claim 1, wherein
a. the at least one display board comprises an area on an item of clothing for a human; and
b. the at least one tracking marker is disposed on the item of clothing.

12. The system of claim 1, further comprising a videographic recorder disposed and configured for receiving the temporal series of input digital images of the scene from the videographic camera and for supplying the temporal series of input digital images to the controller.

13. The system of claim 1, wherein the controller is disposed within the videographic camera.

14. The system of claim 1, wherein the software when executed by the controller is further capable of assigning to pixels of the virtual sub-image within the at least one input digital image a resource location identifier.

15. The system of claim 14, further comprising an interactive display system disposed and configured for receiving from the controller the at least one input digital image containing pixels of the virtual sub-image, pixel coordinate information defining the virtual sub-image within the at least one input digital image, and the resource location identifier assigned to the pixels of the virtual sub-image.

16. The system of claim 15, wherein the display system comprises:
a. a digital pointing and selecting device; and
b. display system software capable when executed by the display system of directing the interactive display system to a resource location identified by the resource location identifier when the digital pointing and selecting device selects within the at least one input digital image pixels of the virtual sub-image.

17. A method for changing the video appearance of a display board present in a temporal series of digital videographic images, the method comprising:
a. obtaining from a videographic camera a temporal series of at least one input digital image containing the display board and at least one vectorized tracking marker rigidly disposed with respect to the display board;
b. determining a three dimensional location and orientation of the at least one tracking marker from the at least one input digital image based on information about the at least one tracking marker in a database;
c. first extracting from the database a fixed three-dimensional location and orientation of the display board relative to the at least one tracking marker;
d. second extracting from the database at least one virtual sub-image associated with the display board;
e. geometrically adapting the at least one virtual sub-image to match a perspective of the videographic camera in the at least one input digital image; and
f. replacing within the at least one input digital image pixels corresponding to the display board with pixels corresponding to the at least one virtual sub-image.

18. The method of claim 17, further comprising storing in the database prior to use information comprising:
a. identifying markings on the at least one tracking marker;
b. geometrical information about at least one of a three-dimensional shape of the at least one tracking marker and a rotationally asymmetric pattern on the at least one tracking marker;
c. the fixed three-dimensional location and orientation of the display board relative to the at least one tracking marker; and
d. the at least one virtual sub-image.

19. The method of claim 18, wherein the storing in the database comprises relating the at least one virtual sub-image to the display board.

20. The method of claim 17, further comprising rigidly disposing the at least one tracking marker with respect to the display board.

21. The method of claim 17, wherein the obtaining the at least one input digital image comprises obtaining from the videographic camera at least one input digital image containing a plurality of vectorized tracking markers rigidly attached to the at least one display board in a fixed three-dimensional spatial relationship with respect to the at least one display board.

22. The method of claim 21, further comprising
a. determining from the three-dimensional location and orientation of the plurality of tracking markers a distortion of the at least one display board; and
b. further adapting the at least one virtual sub-image to match the distortion of the at least one display board in the at least one input digital image.

23. A method for directing an interactive display system to an information source, the method comprising:
a. associating with a set of virtual sub-images in a database a set of corresponding resource location identifiers;
b. replacing at least one portion of at least one input digital image in a temporal series of input digital images from a videographic camera with one of the virtual sub-images while changing the at least one portion based on a changing perspective of the camera;
c. transferring to the interactive display system the changed temporal series of digital images, associated sub-image pixel coordinate information, and the corresponding resource location identifiers;
d. displaying on the interactive display system the changed temporal series of digital images;
e. assigning the corresponding resource location identifiers to the changed portions; and
f. directing the interactive display system to one of the resource locations when a corresponding associated changed portion is selected on the interactive display system.

24. The method of claim 23, wherein the replacing the at least one portion comprises:
a. obtaining from the videographic camera the temporal series of input digital images containing a display board and at least one vectorized tracking marker rigidly disposed with respect to the display board;
b. determining a three dimensional location and orientation of the at least one tracking marker from the at least one input digital image based on information about the at least one tracking marker in the database;
c. first extracting from the database a fixed three-dimensional location and orientation of the display board relative to the at least one tracking marker;
d. second extracting from the database at least one virtual sub-image associated with the display board;
e. geometrically adapting the at least one virtual sub-image to match a perspective of the videographic camera in the at least one input digital image; and
f. replacing within the at least one input digital image pixels corresponding to the display board with pixels corresponding to the at least one virtual sub-image.

25. The method of claim 24, further comprising storing in the database prior to use information comprising:
a. identifying markings on the at least one tracking marker;
b. geometrical information about at least one of a three-dimensional shape of the at least one tracking marker and a rotationally asymmetric pattern on the at least one tracking marker;
c. the fixed three-dimensional location and orientation of the display board relative to the at least one tracking marker; and
d. the at least one virtual sub-image.

26. The method of claim 25, wherein the storing in the database comprises relating the at least one virtual sub-image to the display board.

27. The method of claim 24, further comprising rigidly disposing the at least one tracking marker with respect to the display board.

28. The method of claim 24, wherein the obtaining the at least one input digital image comprises obtaining from the videographic camera at least one input digital image containing a plurality of vectorized tracking markers rigidly attached to the at least one display board in a fixed three-dimensional spatial relationship with respect to the at least one display board.

29. The method of claim 28, further comprising:
a. determining from the three-dimensional location and orientation of the plurality of tracking markers a distortion of the at least one display board; and
b. further adapting the at least one virtual sub-image to match the distortion of the at least one display board in the at least one input digital image.
